(19) United States
(12) Patent Application Publication
(10) Pub. No.: US 2024/0411095 A1
(43) Pub. Date: Dec. 12, 2024

(54) SIGNAL TRANSMISSION DEVICE AND SYSTEM

(71) Applicant: ELKA INTERNATIONAL LTD., New Taipei City (TW)

(72) Inventor: Jui-Ming YANG, New Taipei City (TW)

(73) Assignee: ELKA INTERNATIONAL LTD., New Taipei City (TW)

(21) Appl. No.: 18/737,730

(22) Filed: Jun. 7, 2024

(30) Foreign Application Priority Data
Jun. 8, 2023 (TW) 112205810

(51) Int. Cl. G02B 6/42; H01R 12/71; H01R 13/66; H01R 13/74

(52) U.S. Cl. CPC G02B 6/4293; H01R 12/716; H01R 13/6691; H01R 13/74

(57) ABSTRACT

The present disclosure provides a signal transmission device for setting on a wall. The signal transmission device comprises a circuit board, an electrical signal connector, an optical signal connector, a photoelectric converter, and a power injector. The electrical signal connector is arranged on the circuit board and configured to transmit and receive an electrical signal. The optical signal connector is arranged on the circuit board and configured to transmit and receive an optical signal. The photoelectric converter is placed on the circuit board and coupled between the electrical and optical signal connectors. Selectively. The photoelectric converter selectively converts the electrical signal to the optical signal or the optical signal to the electrical signal. The power injector is arranged on the circuit board and configured to provide working power to the photoelectric converter.

### TECHNICAL FIELD

The present disclosure introduces a novel signal transmission device, specifically designed for wall-mounted applications. This device stands out due to its cutting-edge photoelectric converter, a unique feature that sets it apart from conventional signal transmission devices.

### BACKGROUND

In indoor applications of audio-visual equipment, the distance between a source device and a display device often exceeds the effective distance that a conventional electrical cable can provide. This leads to issues such as signal transmission failure or low transmission efficiency. The novel signal transmission device effectively overcomes these problems, making it a crucial solution in this context.

However, most audio and video devices on the market still support or only support electrical connectors. Although there are connectors for converting optical signals to/from electrical signals, for example, the prior arts (U.S. Pat. No. 11,320,599 B2, U.S. Pat. No. 11,388,374 B2) have disclosed multimedia connectors that convert optical signals and electrical signals, the price and cost of the multimedia connectors is high due to the size limitations of the multimedia connector, and the active components used in the multimedia connector. Specifically, the setting space for active components for converting optical and electrical signals is limited. Selecting components or chips with high integration and refinement levels is necessary to convert multimedia in a restricted space. Therefore, the cost and price of the multimedia connectors are high and cannot be effectively reduced.

In addition, multimedia connectors are only supported by composite transmission cables, which integrate electrical signal lines and optical fibers. Composite transmission cables are expensive and difficult to set up or use due to their large diameter, heavyweight, and hardness.

Therefore, conversion, including both the advantages of optical cable and electrical cable and converting optical and electrical signals effectively for various electronic devices connected in long-distance transmission, will be a major issue in the technical field.

### SUMMARY

One of the objectives of the present disclosure is to provide a signal transmission device and system for optical cable configuration to prevent the optical cables from affecting indoor space's movement flow and avoid damage to the optical cables.

One of the objectives of the present disclosure is to reduce the cost and difficulty of manufacturing the connectors for converting optical and electrical signals.

The present disclosure provides a signal transmission device for setting on a wall. The signal transmission device comprises a circuit board, an electrical signal connector, an optical signal connector, a photoelectric converter, and a power injector. The electrical signal connector is arranged on the circuit board and configured to transmit and receive an electrical signal. The optical signal connector is arranged on the circuit board and configured to transmit and receive an optical signal. The photoelectric converter is positioned on the circuit board and coupled between the electrical and optical signal connectors. The photoelectric converter selectively converts the electrical signal to the optical signal or the optical signal to the electrical signal. The power injector is arranged on the circuit board and configured to provide working power to the photoelectric converter.

In an embodiment, the signal transmission device further comprises a fixed structure combined with the circuit board and configured to fix the circuit board on the wall.

The signal transmission device comprises a panel part combined with the fixed structure in an embodiment. It has an opening corresponding to the electrical signal connector, wherein the circuit board is arranged on the backside of the panel part.

In an embodiment, the signal transmission device further comprises a signal redriver arranged on the circuit board, coupled between the electrical signal connector and the photoelectric converter, and configured to implement a redrive process to the electrical signal transmitted or received by the electrical signal connector.

In an embodiment, the redrive process includes adjusting a gain setting of at least one channel of the electrical signal connector.

In an embodiment, the power injector includes an AC input terminal configured to receive AC power and an AC to DC converter configured to convert the AC power to working power.

In an embodiment, the specification of the electrical signal connector is selected from one of HDMI, DP, and USB.

In an embodiment, the specification of the optical signal connector is selected from one of LC, SC, and MPO.

The present disclosure provides a signal transmission system. The signal transmission system comprises a first signal transmission device, a second signal transmission device, and an optical cable. The first signal transmission device includes a first circuit board, a first electrical signal connector arranged on the first circuit board, a first optical signal connector arranged on the first circuit board, a first photoelectric converter arranged on the first circuit board, and coupled between the first electrical signal connector and the first optical signal connector, and a first power injector arranged on the first circuit board and configured to provide first working power to the first photoelectric converter. The second signal transmission device comprises a second circuit board, a second electrical signal connector arranged on the second circuit board, a second optical signal connector arranged on the second circuit board, a second photoelectric converter arranged on the second circuit board and coupled between the second electrical signal connector and the second optical signal connector, and the second power injector arranged on the second circuit board, and configured to provide second working power to the second photoelectric converter, and an optical cable configured to connect the first signal transmission device and the second signal transmission device. The first signal transmission device is arranged in the first position, and the second signal transmission device is arranged in the second position. The optical cable is arranged along a wall where the first position is located. The first optical signal connector is configured to transmit a first optical signal to the second optical signal connector or receive a second optical signal from the second optical signal connector via the optical cable. The first photoelectric converter is configured to convert the first electrical signal received from an electrical device to the first optical signal or convert the second optical signal to a second electrical signal transmitted to the electrical device.

In an embodiment, the first signal transmission device further comprises a first fix structure combined with the first circuit board and configured to fix the first circuit board on the wall.

In an embodiment, the first signal transmission device comprises a first panel part combined with the first fixed structure. It has a first opening corresponding to the first electrical signal connector, wherein the first circuit board is arranged on the first backside of the first panel part.

In an embodiment, the first signal transmission device further comprises a first signal redriver arranged on the first circuit board and coupled between the first electrical signal connector and the first photoelectric converter and configured to implement a first redrive process to modify the first electrical signal or the second electrical signal.

In an embodiment, the redrive process includes adjusting a gain setting of at least one channel of the first electrical signal connector.

In an embodiment, the first signal transmission device's first power injector includes an AC input terminal configured to receive AC power and a first AC to DC converter configured to convert the AC power to the first working power.

In an embodiment, the specification of the first electrical signal connector of the first signal transmission device is selected from one HDMI, DP, and USB.

In an embodiment, the specification of the first optical signal connector of the first signal transmission device is selected from one of LC, SC, and MPO.

In an embodiment, the second signal transmission device has a second signal redriver; the second signal transmission device is configured to provide the first electrical signal to a display device via an electrical signal cable.

Through the signal transmission device fixed on the wall and equipped with a photoelectric converter, the optical cables used for long-distance transmission can be arranged inside or on the wall. In addition, conventional electrical devices that are not available for optical transmission can connect to the electrical signal connector of the signal transmission device via an electrical signal cable. In this way, the signal transmission device provides both optical and electrical cable advantages to achieve a better configuration for optical and electrical cable. Moreover, the setting space for the photoelectric converter in the signal transmission device fixed on the wall is larger than the space for an integrated connector. Due to the setting space for the photoelectric converter in the signal transmission device is not limited by the size of the connector, the selection of circuit components will be more comprehensive, the configuration/layout of the circuit board will be more accessible, and the specifications or difficulty of the circuit fabrication will be lower than an integrated connector. Accordingly, manufacturing the signal transmission device can also significantly reduce the cost or price.

### BRIEF DESCRIPTION OF THE DRAWINGS

The accompanying drawings are presented to help describe various aspects of the present disclosure. To simplify the accompanying drawings and highlight the contents to be presented in the accompanying drawings, conventional structures or elements in the accompanying drawings may be drawn in a simple schematic way or may be omitted. For example, several elements may be singular or plural. These accompanying drawings are provided merely to explain these aspects and not to limit them.

FIG. 1 is a schematic diagram of the signal transmission device according to the first embodiment of the present disclosure.

FIG. 2 is a schematic diagram of another perspective of the signal transmission device according to the first embodiment of the present disclosure.

FIG. 3 is a block diagram of the circuit board according to the first embodiment of the present disclosure.

FIG. 4 is a block diagram of the power injector according to the first embodiment of the present disclosure.

FIG. 5 is a schematic diagram of the decomposition of the signal transmission device according to the second embodiment of the present disclosure.

FIG. 6 is a schematic diagram of the combination of signal transmission devices according to the second embodiment of the present disclosure.

FIGS. 7A to 7C are schematic diagrams of the combination of signal transmission devices from another perspective according to the second embodiment of the present disclosure.

FIG. 8 is a schematic diagram of the decomposition of the signal transmission device according to the third embodiment of the present disclosure.

FIG. 9 is a block diagram of a circuit board with a signal redriver according to the fourth embodiment of the present disclosure.

FIG. 10 is a schematic diagram of the signal transmission system according to the fifth embodiment of the present disclosure.

FIGS. 11 to 12 are schematic diagrams of the signal transmission system connected with peripheral devices according to the fifth embodiment of the present disclosure.

### DETAILED DESCRIPTION

Any reference to elements using terms such as “first” and “second” herein generally does not limit the number or order of these elements. Conversely, these names are used herein as a convenient way to distinguish two or more elements or element instances. Therefore, it should be understood that the terms “first” and “second” in the requested item do not necessarily correspond to the same names in the written description. Furthermore, it should be understood that references to the first and second elements do not indicate that only two elements can be used or that the first element needs to precede the second element. Open terms such as “include,” “comprise,” “have,” “contain,” and the like used herein mean including but not limited to.

The term “coupled” is used herein to refer to direct or indirect electrical coupling between two structures. For example, in indirect electrical coupling, one structure may be coupled with another through a passive element, such as a resistor, a capacitor, or an inductor.

In the present disclosure, terms such as “exemplary” or “for example” are used to represent “giving an example, instance, or description.” Any implementation or aspect described herein as “exemplary” or “for example” is not necessarily to be construed as preferred or advantageous over other aspects of the present disclosure. The terms “about” and “approximately” as used herein concerning a specified value or characteristic are intended to represent within a value (for example, 10%) of the specified value or characteristic.

In the present disclosure, the term “wall” refers to a structure for establishing a building or an indoor space, a continuous structure that encloses or divides an area of land, a partition for separating two rooms, a main structure of large furniture (such as cabinets) and/or a structure with thickness located inside a room or building. In the present disclosure, the form of the wall may include but is not limited to, upright walls (with load-bearing), decoration walls (without load-bearing), partition walls, ceilings, floors, and/or any positions that are available to set a wall panel(s).

### First Embodiment

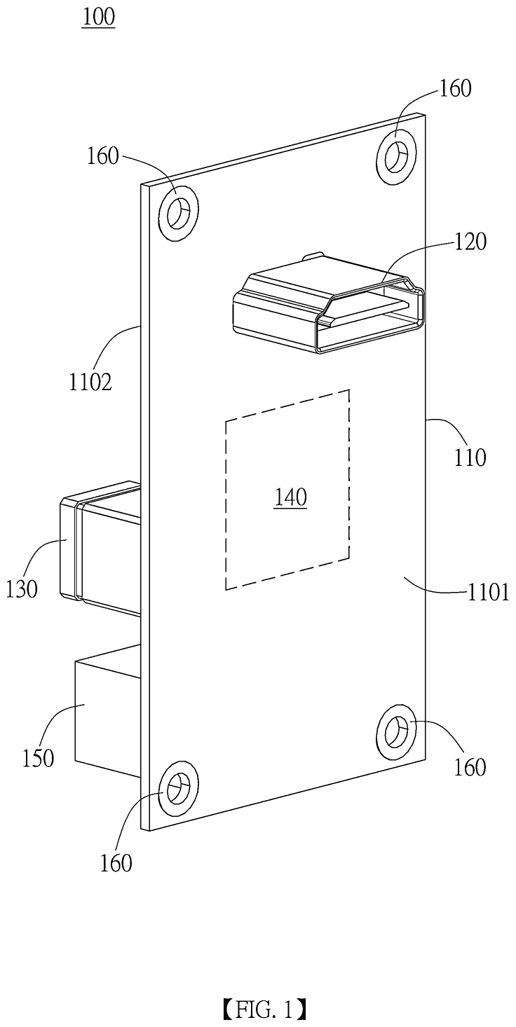

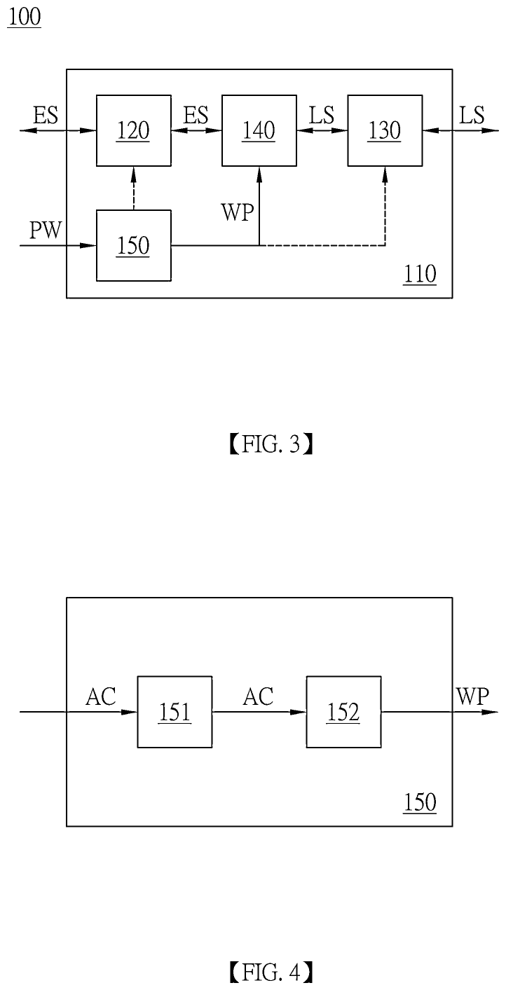

Referring to FIGS. 1 to 3, FIGS. 1 to 3 illustrates a signal transmission device 100. The signal transmission device 100 includes a circuit board 110, an electrical signal connector 120 arranged on the circuit board 110 and configured to transceiver (transmit and/or receive) an electrical signal (ES), an optical signal connector 130 arranged on the circuit board 110 and configured to transceive an optical signal (LS), a photoelectric converter 140 arranged on the circuit board 110 and coupled between the electrical signal connector 120 and the optical signal connector 130, and a power injector 150 arranged on the circuit board 110. The photoelectric converter 140 converts selectively the electrical signal (ES) to the optical signal (LS) or the optical signal (LS) to the electrical signal (ES). The power injector 150 is configured to provide a working power (PW) to the photoelectric converter 140.

In the embodiment shown in FIG. 1, the signal transmission device 100 can be installed/fixed on the wall through a fixed structure 160 combined with the circuit board 110. For example, the fixed structure 160 can be directly formed on the circuit board 110. In the example for forming the fixed structure 160 on the circuit board 110, the fixed structure 160 can be formed as fixing holes for screws to pass through. The signal transmission device 100 can be fixed on the wall by screwing screws into the wall. It should be noted that the present disclosure is not limited to the fixing means for fixing the fixed structure 160 to the wall. Specifically, the signal transmission device 100 can also be fixed to the wall by adhesive, locking, clamping, or embedding means. Although FIG. Illustrates that fixed structure 160 is located at the corner of the circuit board 110; fixed structure 160 is not necessarily located at the corner position of the circuit board 110. The fixed structure 160 can also be a protruding part reserved during the cutting of the substrate of the circuit board 110. In other words, the fixed structure 160 can be placed in any suitable position on the circuit board 110 and directly integrated.

The electrical signal connector 120 can be a plug or a socket. A plug may refer to male contacts with sticking-out structures, such as male connectors, pins, and other contacts. On the other hand, sockets may refer to female contacts, such as female connectors, pin sockets, and contacts that are used for setting male contacts. Generally, male and female contacts can be exchanged and/or replaced equivalently without affecting the present disclosure's implementation. On the other hand, the electrical signal connector 120 may correspond to various specifications. For example, the electrical signal connector 120 can be (for example, but not limited to) a Universal Serial Bus (USB), a High-Definition Multimedia Interface (HDMI), a DisplayPort (DP), and other connectors for transmitting high-frequency signals. It should be noted that the electrical signal connector 120 can be set at any position of the circuit board 110 for insertion. In a preferred implementation, the electrical signal connector 120 is preferably set on the first surface 1101 of the circuit board 110. Specifically, after fixing the signal transmission device 100 to the wall, the first surface 1101 of the circuit board 110 faces the user and/or has the same standard line direction as the wall. This way, the electrical signal connector 120 set on the first surface 1101 is more reachable and easily connected for the user.

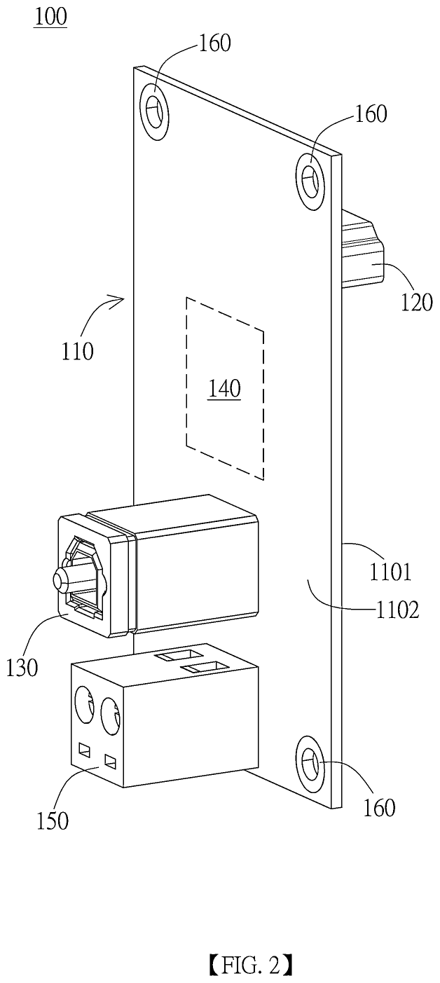

Similarly, the optical signal connector 130 can be a plug or a socket. The plug and socket for the optical signal connector 130 can also be exchanged and/or replaced. The specifications of the optical signal connector 130 may selected from LC, SC, MPO, or any other well-known optical signal formation, but are not limited to. It should be noted that the optical signal connector 130 can also be set at any position of the circuit board 110 for insertion. In a preferred implementation, as shown in FIG. 2, the optical signal connector 130 is set on the second surface 1102 of the circuit board 110. Specifically, the second surface, 1102, is opposite to the first surface, 1101. In other words, the optical signal connector 130 and the electrical signal connector 120 will face in different directions. Preferably, the optical signal connector 130 is oriented towards the wall and/or hidden in the wall. Therefore, while an optical cable is buried inside the wall and inserted into the signal transmission device 100 through the optical signal connector 130, the optical cable will suffer less interference. However, the orientation of the optical signal connector 130 is not limited. Specifically, in the present disclosure, the orientation of the optical signal connector 130 is prioritized for the convenience of installing/inserting the optical cable. Accordingly, the electrical signal connector 120 can be set on the same or different surface of the circuit board 110 as the optical signal connector 130. In other words, the optical signal connector 130 of the present disclosure can be selectively arranged on one of the first surfaces, 1101, and a second surface, 1102, of the circuit board 110, and the electrical signal connector 120 can be arranged on the other or the same surface as the optical signal connector 130. In addition, the optical cable does not necessarily have to be buried inside the wall. The optical cable can also be installed along the wall's surface and connected to the optical signal connector 130 of the signal transmission device 100 outside the wall.

The photoelectric converter 140 is coupled between the electrical signal connector 120 and the optical signal connector 130. Specifically, the photoelectric converter 140 is arranged on the circuit board 110 and can be implemented by integrating various circuit components and integrated chips (ICs). For example, the circuit components can be but are not limited to, photosensitive elements, light-emitting elements, or other components commonly used in a conventional optical circuit. The ICs can be components with computational functions, such as microprocessors, FPGAs, and/or Application Specific Integrated Circuits (ASICs). The photoelectric converter 140 is configured to convert the optical signal (LS) transceived by the optical signal connector 130 into the corresponding electrical signal (ES) transceived by the electrical signal connector 120. For example, If the electrical signal connector 120 is HDMI, the photoelectric converter 140 will transceive the optical signal (LS) through the optical cable and convert the optical signal (LS) into the electrical signal (ES) capable of transceiver via HDMI. Conversely, the photoelectric converter 140 is configured to convert the electrical signal (ES) transceived by the electrical signal connector 120 into the optical signal (LS) transceived by the optical signal connector 130. The arrangement space compared for the photoelectric converter 140 in the signal transmission device 100 is less restricted compared to conventional connectors because conventional connectors have to fit regulations or specifications compared to conventional connectors because conventional connectors have to fit the regulations or specifications of cables. A conventional HDMI connector's width is approximately 0.6 to 1.4 cm. However, the signal transmission device 100 can be sized as a conventional wall plate for an electrical socket (e.g., length: 7-12 cm, width: 5-8 cm). Besides, because the signal transmission device 100 is arranged on the wall's surface or embedded into the wall, the height or depth of the arrangement space for the photoelectric converter 140 is adjustable for a wider range than the conventional connectors. It should be noted that the above dimensions are only used to demonstrate the size advantages of the signal transmission device 100 compared to conventional connectors. They are not intended to limit the size of the signal transmission device 100 of the present disclosure.

In this embodiment, the circuit board 110 further includes a power injector 150, which is configured to provide the working power (WP) required by the photoelectric converter 140. Specifically, the power injector 150 receives power (PW) from a power source outside the circuit board 110. It converts the power (PW) into the required working power (WP) (e.g., DC 5V) for the photoelectric converter 140 or directly provides the power (PW) as the required working power (WP) without conversion. In addition, the power supply of the power injector 150 can also be provided to the electrical signal connector 120 and/or the optical signal connector 130 for supporting transmission. In a preferred implementation, as shown in FIG. 4, the power injector 150 is set on the second surface 1102 of the circuit board 110 and includes an AC input terminal 151 and an AC to DC converter 152. The AC input terminal 151 receives an AC power (AC), and the AC to DC converter 152 converts the AC power (AC) into at least the working power (WP). Specifically, the power injector 150 located on the second surface 1102 of the circuit board 110 can be directly connected to an AC wire pair buried inside the wall (e.g., AC 110V) and converted by the AC to DC converter 152, the AC power (AC) to the working power (WP) required by the photoelectric converter 140, the electrical signal connector 120, and/or the optical signal connector 130. The power requirement of the signal transmission device 100 can be satisfied by the AC wire pair buried inside the wall, which is directly connected to the signal transmission device 100. Furthermore, exposing the power line outside the wall will cause wiring chaos and affect the visual effects. With the AC input terminal 151 and the AC to DC converter 152, the AC power will be directly provided to the signal transmission device 100 without exposing any power line outside the wall. In addition, in one embodiment, the working power (WP) required by the photoelectric converter 140 does not necessarily need to be provided by the power injector 150. In other words, the power injector 150 is not necessary, and the working power (WP) can be provided by an electrical signal cable connected to the electrical signal connector 120 or a composite optical cable, having electrical lines connected to the optical signal connector 130.

In the embodiment, the signal transmission device 100 is directly installed on the wall by the fixed structure 160 combined with the circuit board 110, which can achieve the goal in the simplest means. Compared to the size of the conventional multimedia connector, the circuit board 110 of the signal transmission device 100 has a larger arrangement size. Therefore, cheaper and larger circuit components can be selected for the circuit board 110. The difficulty and precision requirements for producing the circuit board 110 will also be reduced. Accordingly, the cost of converting the photoelectric signals will be significantly reduced.

### Second Embodiment

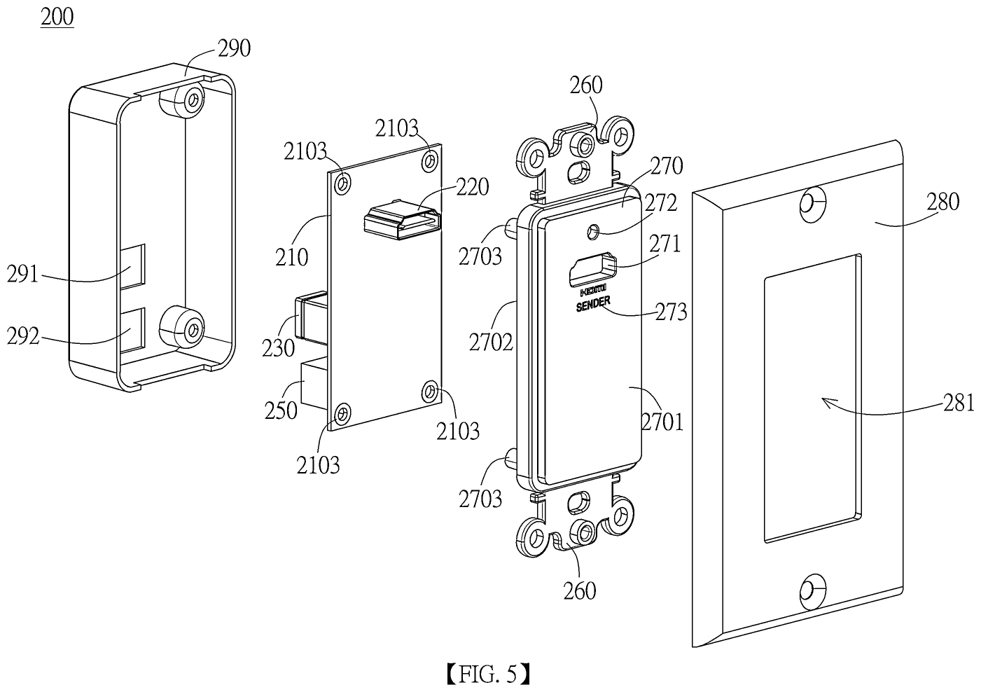

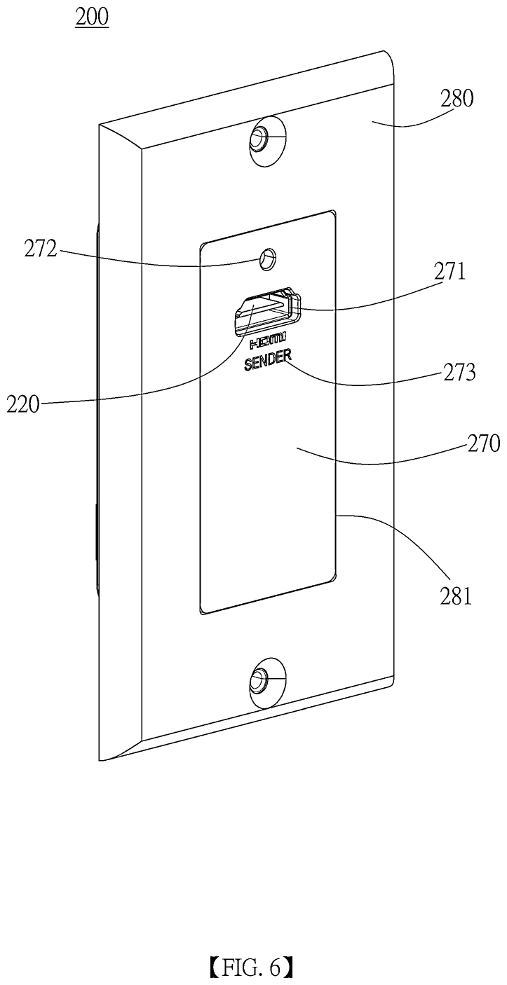

In this embodiment, the signal transmission device 200 can be installed on the wall by a fixed structure 260, indirectly combined with the circuit board 210. As shown in FIGS. 5 to 6, the signal transmission device 200 includes a panel part 270 combined with the fixed structure 260, which has an opening 271 corresponding to the electrical signal connector 220. The circuit board 210 is located on the back surface 2702 of panel part 270. Specifically, the circuit board 210 can be combined with the fixing point 2703 of the panel part 270 through the fixing hole 2103 on the circuit board 210, but the means for combining the circuit board 210 with the panel part 270 is not limited to this. The panel part 270 can be integrated with the fixed structure 260; for example, during plastic molding, the panel part 270 can be molded with the fixed structure 260 or manufactured separately from the fixed structure 260, then assembly the panel part 270 and the fixed structure 260. After fixing the circuit board 210 to the panel part 270, the circuit board 210 is indirectly combined with the fixed structure 260. By fixing structure 260, the signal transmission device 200 can be securely installed in a groove or concave of the wall. When the electrical signal connector 220, the optical signal connector 230, or other connectors (such as the power injector 250) of the circuit board 210 are inserted by cable connectors, the fixed structure 260 provides stable support for the signal transmission device 200 to avoid the signal transmission device 200 being pulled or pushed by the force created by inserting the cable connectors or the tension of the optical cable or the electrical transmission cable.

On the other hand, the opening 271 of the panel part 270 penetrates through the front surface 2701 and the back surface 2702 of the panel part 270. The opening 271 corresponds to the appearance/cross-section of the electrical signal connector 220. For example, when the electrical signal connector 220 is HDMI, the size and shape of the opening 271 are configured to be suitable for HDMI. Opening 271 can also be configured according to the cross-section of the electrical signal connector 220 to provide users with better identification and mistake-proofing. With the panel part 270 and the opening 271, the signal transmission device 200 can be made more concise after being placed on the wall. In other words, the panels' part 270 and the opening 271 make users focus on the electrical signal connector 220 instead of all the parts of the circuit board 210. The front 2701 of panel 270 can also be equipped with the light indicator 272 and/or printed with the text/symbol 273 near the opening 271 for users to identify the status or type of the electrical signal connector 220 and avoid improper insertion or misuse of the corresponding connector. However, the functional purpose of the panel section 270 is not limited to the above examples.

In this embodiment, referring to FIGS. 5 and 6. The signal transmission device 200 further includes an external decorative panel 280. After the signal transmission device 200 is fixed to the wall, the external decorative panel 280 at least partially covers the fixed structure 260 and does not cover the electrical signal connector 220. The external decorative panel 280 can effectively conceal the fixed structure 260 to improve the visual effect of the signal transmission device 200. The external decorative panel 280 also protects the fixed structure 260 from being damaged by external forces. For example, after the external decorative panel 280 covers the fixed structure 260, it is difficult for others to directly contact the fixed structure 260, resulting in problems such as loosening the fixed structure 260. It should be noted that although the empty part 281 of the external decorative panel 280 is shown in FIGS. 5 and 6 are set in conjunction with the panel part 270, the external decorative panel 280 and the panel part 270 can be merged or implemented separately.

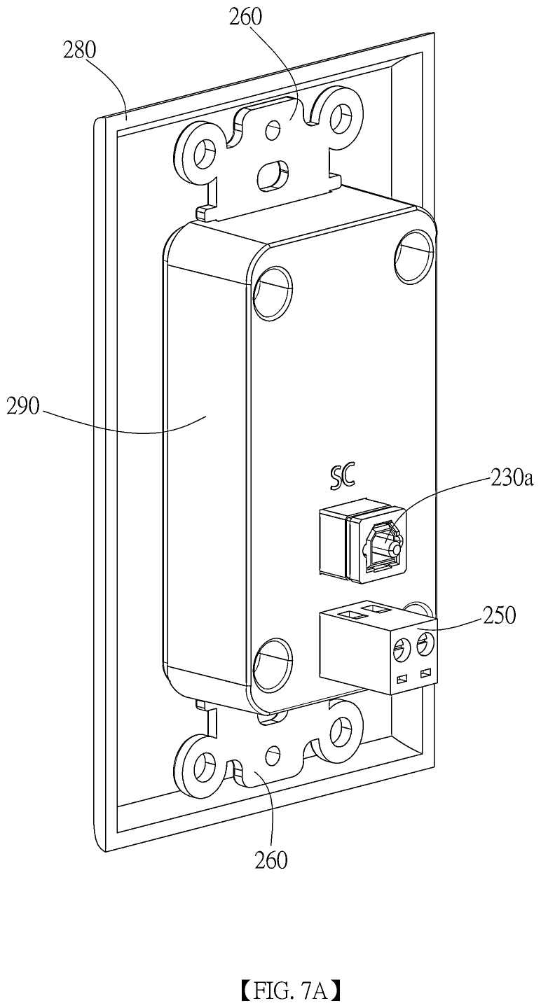

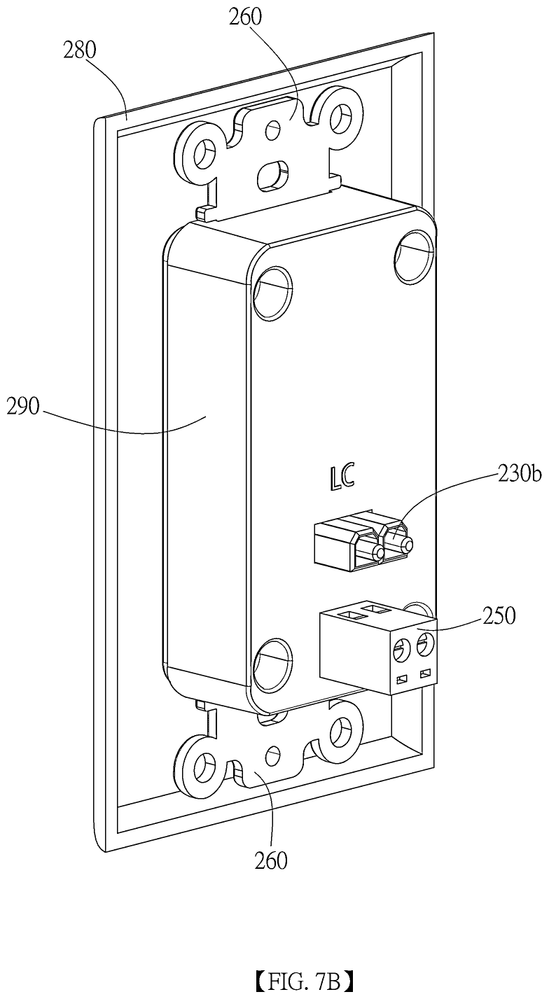

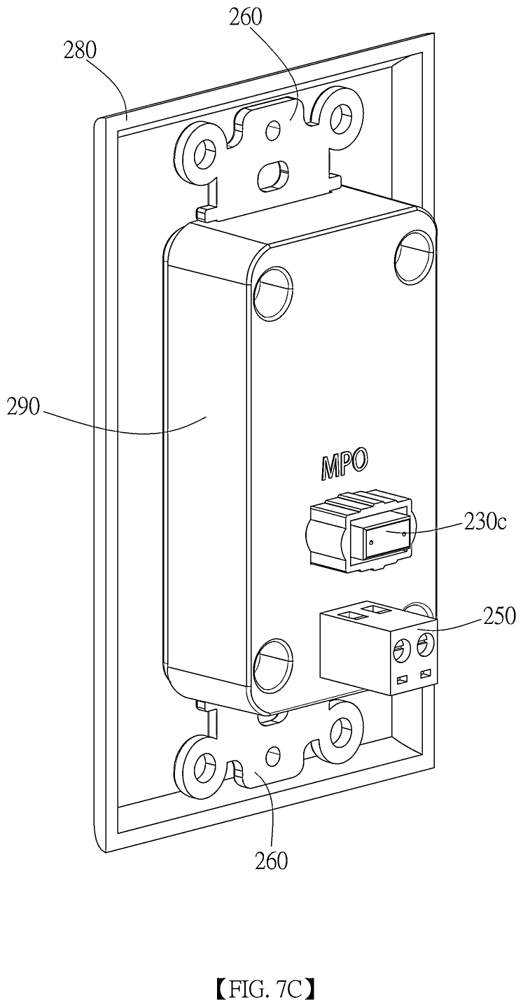

In this embodiment, please refer to FIGS. 7A to 7C. The signal transmission device 200 includes a back shell 290, forming a case with the panel part 270. The case forms an accommodating space to arrange the circuit board 210 and fix it inside the case. Specifically, when the fixed structure 260 of panel part 270 is fixed to the wall, the circuit board 210 located on back 2702 of panel part 270 is fixed to the wall, the circuit board 210 located on back 2702 of panel part 270 will be located inside the groove of the wall. The back shell 290 has an opening(s) 291 for the optical signal connector 230. The opening(s) 291 will be formed according to different specifications of the optical signal connector 230 (such as SC 230a, LC 230b, or MPO 230c). Furthermore, the opening(s) 292 may be formed for the power injectors 250 to avoid interference on the mechanism while inserting a power cable to the power injectors 250. It should be noted that the opening(s) 291 and the opening(s) 292 may be set on either side of the back shell 290 to match the optical cable, or the power cable comes from various ways. In addition, in an application example, the signal transmission device 200 can be fixed by tightly fitting the back shell 290 into a groove in the wall to simplify installation tools and installation time for installing the signal transmission device 200. The case formed by the back shell 290 and the panel part 270 effectively protects the circuit board 210 to prevent installed damage (such as compression or squeeze during installation and invasion by insects and mice after installation). On the other hand, the case formed by the back shell 290 and the panel part 270 also provides the function of being waterproof and/or dust-proof to avoid short circuits or rust of circuit components on circuit board 210 due to dust or moisture. However, the purpose of setting the case is not limited to the above examples.

### Third Embodiment

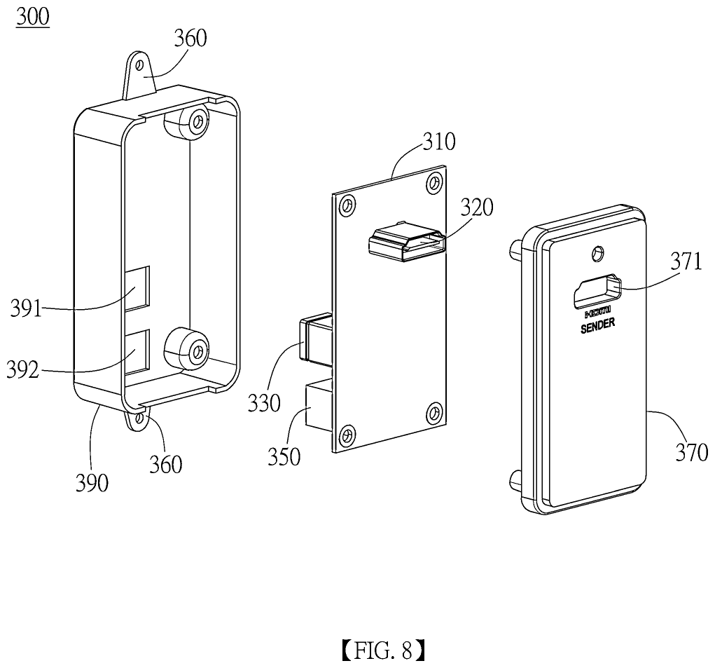

FIG. 8 illustrates another example of the circuit board being indirectly combined with a fixed structure. Referring to FIG. 8, the signal transmission device 300 includes a housing formed by a panel part 370 and a back shell 390. The housing provides an accommodating space for the circuit board 310 to be set inside the housing. The panel part 370 has an opening 371 corresponding to the electrical signal connector 320. The back shell 390 has an opening of 391 and 392, respectively, to the optical signal connector 330 and the power injector 350. It should be noted that the positions of the opening 391 and the opening 392 can also be located on either side of the back shell 390. The fixed structure 360 is set on the back shell 390. Specifically, the circuit board 310 is located inside the housing and is indirectly combined with the fixed structure 360 by the back shell 390. The fixed structure 360 of the housing is configured to fix the signal transmission device 300 on the wall's surface. In this way, the signal transmission device 300 can be installed without damaging the wall (i.e., digging out a groove for the signal transmission device 300). The housing provides a flexible installation means for the signal transmission device 300. The housing also protects the circuit board 310 of the signal transmission device 300 to prevent damage from external forces or interference. On the other hand, the housing also provides the function of being waterproof and/or dust-proof to avoid short circuits or rusting of circuit components on circuit board 310 due to dust or moisture. The housing may be formed by conducting materials; therefore, the housing will be formed as a Faraday cage for the circuit board 310 to prevent external noise. However, the purpose of setting the housing is not limited to the above examples.

It should be noted that the housing is not limited to being composed of a panel part and a back shell. For example, a front shell with an accommodating space and a sheet-like back plate can also form the housing. The housing may be in any possible shape to match the shape, thickness, and/or size of the circuit board 310, any possible shape to match the shape, thickness, and/or size of the circuit board 310 and be integrated with the circuit board 310 by any conventional method.

### Fourth Embodiment

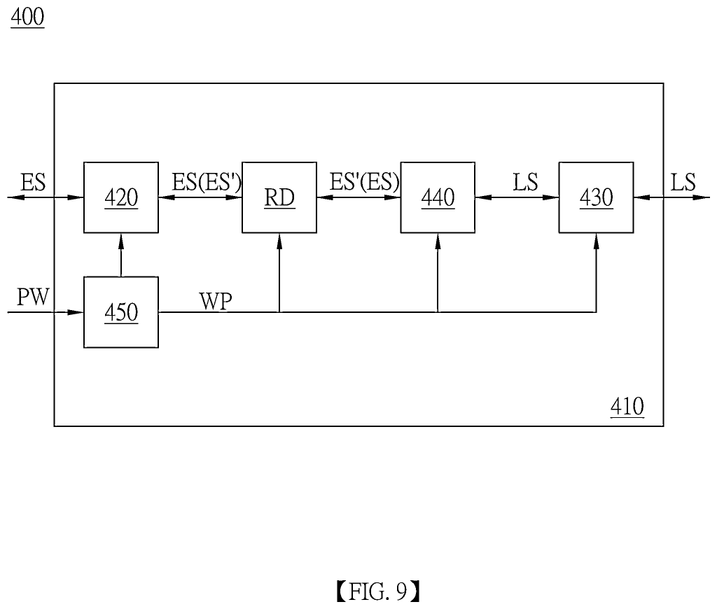

In the embodiment, referring to FIG. 9. The signal transmission device 400 may have a signal redriver (RD). The signal redriver (RD) is coupled between the electrical signal connector 420 and the photoelectric converter 440. The signal redriver (RD) is configured to enhance, modulate, or remake the electrical signal (ES) transceived by the electrical signal connector 420 into a processed electrical signal (ES′). The signal redriver (RD) can also be configured to adjust and/or correct the gain value of any electrical signal connector 420 channel by implementing a redrive process such as equalization, pre-emphasis, or other means. Preferably, the gain or other parameters of the electrical signal (ES) should be regulated within a specific frequency band to fit the regulation or specification of the electrical signal connector 420. Therefore, the signal redriver (RD) effectively improves the signal transmission quality of the electrical signal (ES) transceived by the electrical signal connector 420 of the signal transmission device 400. It should be noted that the signal redriver (RD) shown in FIG. 9 redrives the electrical signal (ES) received by the electrical signal connector 420 to the processed electrical signal (ES′). The processed electrical signal (ES′) is converted into an optical signal (LS) by the photoelectric converter 440; the direction of transmitting the signal of the present disclosure is not limited by the example shown in FIG. 9. In other words, the direction of transmitting the signal can be reversed. Specifically, the optical signal (LS) received by the optical signal connector 430 can be converted into the electrical signal (ES) by the photoelectric converter 440. The electrical signal (ES) can be redrived by the signal redriver (RD) to the processed electrical signal (ES′) provided to and output by the electrical signal connector 420.

### Fifth Embodiment

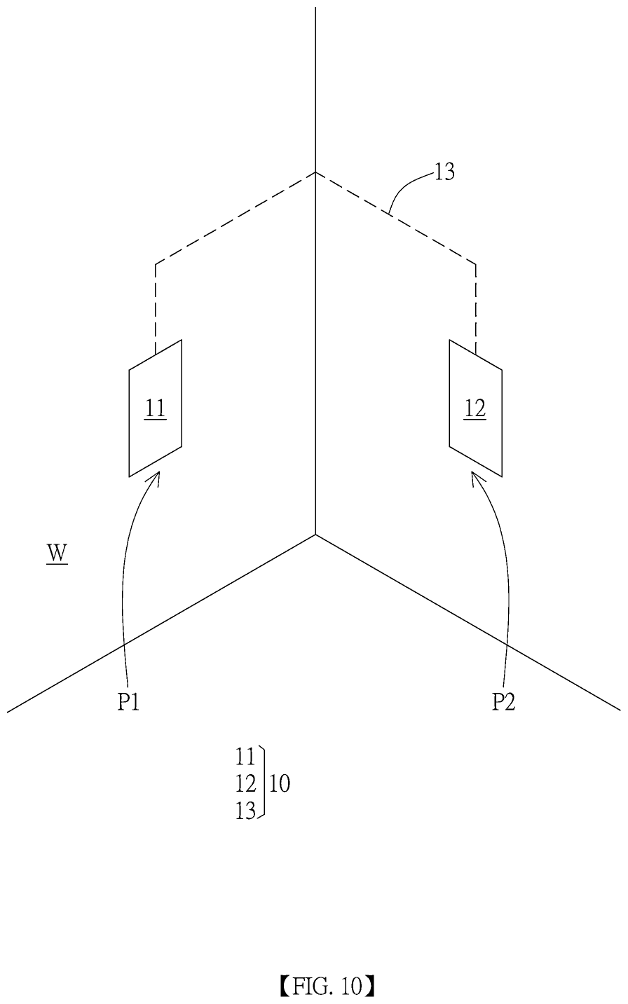

A signal transmission system 10 includes a first signal transmission device 11, a second signal transmission device 12, and an optical cable 13. The first signal transmission device, 11, is arranged at the first position (P1), and the second signal transmission device, 12, is arranged at the second position (P2). The optical cable 13 is arranged at least along the wall (W) where the first position (P1) is located. Specifically, the signal transmission system 10 comprises at least two or more signal transmission devices of any of the above embodiments, and signal transmission devices are connected by an optical cable(s). As shown in FIG. 10, the first signal transmission device 11 and the second signal transmission device 12 can be installed on the wall (W) surface and connected by the optical cable 13. the optical cable 13 can be installed along the wall (W) to minimize the interference of the movement flow of an indoor space. On the other hand, the first signal transmission device 11 and the second signal transmission device 12 can also be embedded inside the wall (W), and the optical cable 13 can also be buried inside the wall (W). The embedded and buried arrangement provides a function to effectively reduce the indoor space occupied by the signal transmission system 10. It should be noted that FIG. 10 is only an example and is not intended to limit the present disclosure; accordingly, the first position (P1) and the second position (P2) may be located on the same wall (W) or different walls. Moreover, the application field of the signal transmission system 10 is not limited to an indoor space or a single room. Specifically, if the optical cable 13 is available or supported, the first signal transmission device 11 and the second signal transmission device 12 of the signal transmission system 10 can be located separately in different spaces (even two buildings).

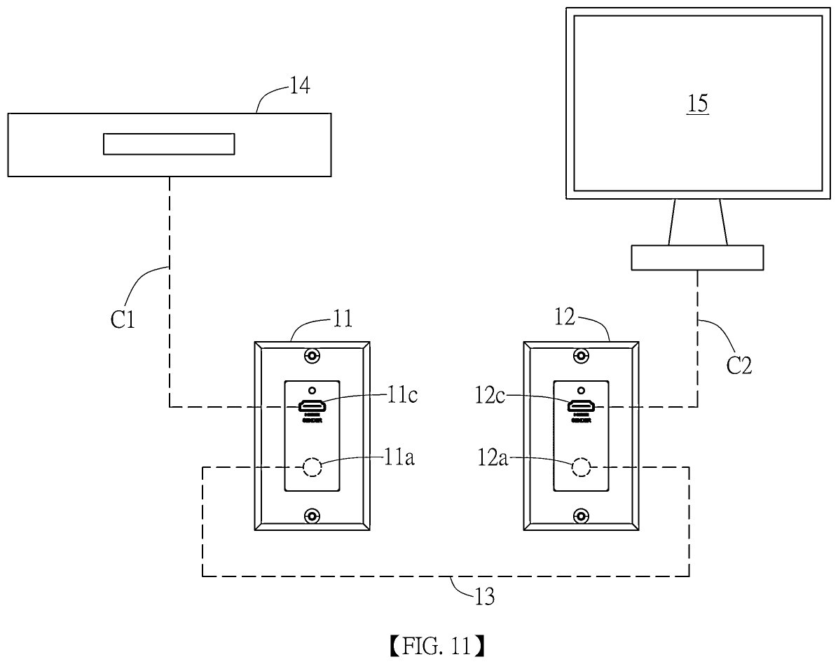

In summary, the first signal transmission device 11 with a photoelectric converter transmits/receives an optical signal to/from the second signal transmission device 12 via the optical cable 13 arranged on/inside the wall (W). Both the electrical signal connectors of the first signal transmission device 11 and the second signal transmission device 12 allow users to connect electrical devices via any conventional electrical signal cables. For example, as shown in FIG. 11, the first signal transmission device 11 can be connected to a video signal source device 14, such as an onboard box or computer, by connecting an electrical signal cable (C1) inserted into the electrical signal connector (11c); the second signal transmission device 12 can be connected to a video output (display) device 15, such as a projector and display, by connecting an electrical signal cable (C2) inserted into the electrical signal connector (12c). Furthermore, the optical signal connector (11a) of the first signal transmission device 11 can be connected or coupled to the optical signal connector (12a) of the second signal transmission device 12 via the optical cable 13. In this arrangement, the optical cable 13 provides advantages such as long-distance transmission, low insertion loss, and/or larger bandwidth. Although the electrical signal cables (C1) and (C2) are not available for long-distance transmission, the communication between the first signal transmission device 11 and the second signal transmission device 12 will not be limited by the distance or shortages of the electrical signal cables (C1) and (C2). Furthermore, device 14 and video output 15 will be limited by a lack of a video signal source. Device 14 and video output device 15 will be limited by a lack of an optical interface or connecting optical cables. Specifically, the signal transmission system 10 makes the video signal source device 14 and the video output device 15 transmit or receive signal in electrical form, which is suitable for a short-distance transmission with lower cost and easy to obtain or install. Therefore, the signal transmission system 10 can balance the advantages of the optical signal transmission and the electrical signal transmission. Moreover, the photoelectric converter set on the signal transmission device will have a larger arrangement space and not be limited by the board circuit board size. Accordingly, the cost, price, or difficulty of implementing a photoelectric converter can be reduced.

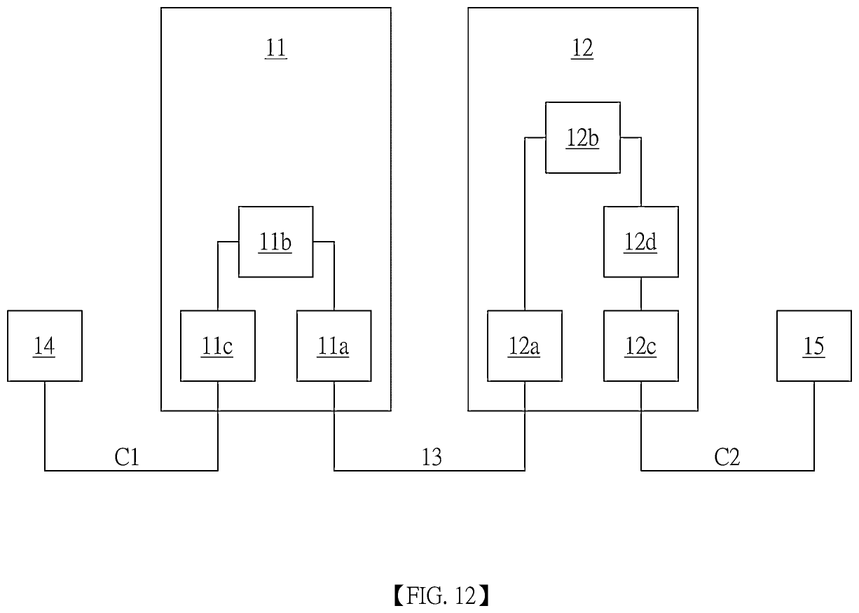

In a preferred application, as shown in FIG. 12, the second signal transmission device, 12 15, is configured to connect the video output 15, which has a signal redriver (12d). The signal redriver (12d) redrives the electrical signal between the photoelectric converter (12b) and the electrical signal connector (12c). Therefore, the signal redriver (12d) effectively improves the transmission quality of the electrical signal provided to the video output 15. Accordingly, no matter the distance between the first signal transmission device 11 and the second signal transmission device 12, the second signal transmission device 12 will provide an electrical signal with stable quality to the video output 15 due to the drive process being performed at the output terminal of the signal transmission system 10. It should be noted that the present disclosure is not limited to this application example; therefore, the first signal transmission device 11 can also have a signal redriver (not shown in FIG. 12) between the photoelectric converter (11b) and the electrical signal convertor (11c). In this way, no matter the output terminal of the signal transmission system 10, the first signal transmission device 11 and/or the second signal transmission device 12 will provide electrical signals with stable quality to the device (e.g., the video signal source device 14 or the video output 15). Furthermore, because the signal redriver provides the signal modulation or enhancement function, the specification requirement of the electrical signal transmission cables (C1) and (C2) can be reduced. Specifically, the transmission cables C1 and C2 can be selected from the lower specification or passive transmission cables (i.e., transmission cables without active driver chips) to achieve the target quality of the signal. Accordingly, the signal redriver reduces the cost of the electrical signal transmission cables (C1) and (C2). On the other hand, the arrangement space for the signal redriver on the circuit board of the signal transmission device is less limited compared to the conventional active cable. Accordingly, the cost, price, or difficulty of implementing signal driving can be reduced.

The previous description of the present disclosure is provided to enable a person of ordinary skill in the art to make or implement the present invention. Various modifications to the present invention will be apparent to a person skilled in the art, and the general principles defined herein can be applied to other variations without departing from the spirit or scope of the present disclosure. Therefore, the present invention is not intended to be limited to the examples described herein but is in accord with the most comprehensive scope consistent with the principles and novel features of the invention herein.

What is claimed is:

1. A signal transmission device for setting on a wall, comprising:
a circuit board;
an electrical signal connector arranged on the circuit board and configured to transmit and receive an electrical signal;
an optical signal connector arranged on the circuit board and configured to transmit and receive an optical signal;
a photoelectric converter arranged on the circuit board and coupled between the electrical signal connector and the optical signal connector, wherein the photoelectric converter selectively converts the electrical signal to the optical signal or the optical signal to the electrical signal; and
a power injector arranged on the circuit board and configured to provide a working power to the photoelectric converter.

2. The signal transmission device of claim 1, further comprising:
a fix structure combined with the circuit board and configured to fix the circuit board on the wall.

3. The signal transmission device of claim 2, further comprising:
a panel part combined with the fix structure, and having an opening corresponding to the electrical signal connector, wherein the circuit board is arranged on a backside of the panel part.

4. The signal transmission device of claim 1, further comprising:
a signal redriver arranged on the circuit board and coupled between the electrical signal connector and the photoelectric converter, and configured to implement a redrive process for the electrical signal transmitted or received by the electrical signal connector.

5. The signal transmission device of claim 4, wherein the redrive process includes adjusting a gain setting of at least one channel of the electrical signal connector.

6. The signal transmission device of claim 1, wherein the power injector includes an AC input terminal configured to receive an AC power, and an AC to DC converter configured to convert the AC power to the working power.

7. The signal transmission device of claim 1, wherein the specification of the electrical signal connector is selected from one of HDMI, DP and USB.

8. The signal transmission device of claim 1, wherein the specification of the optical signal connector is selected from one of LC, SC and MPO.

9. A signal transmission system comprising:
a first signal transmission device comprising:
a first circuit board;
a first electrical signal connector arranged on the first circuit board;
a first optical signal connector arranged on the first circuit board;
a first photoelectric converter arranged on the first circuit board and coupled between the first electrical signal connector and the first optical signal connector, and
a first power injector arranged on the first circuit board and configured to provide a first working power to the first photoelectric converter;
a second signal transmission device comprising:
a second circuit board;
a second electrical signal connector arranged on the second circuit board;
a second optical signal connector arranged on the second circuit board;
a second photoelectric converter arranged on the second circuit board and coupled between the second electrical signal connector and the second optical signal connector, and
a second power injector arranged on the second circuit board and configured to provide a second working power to the second photoelectric converter; and
an optical cable configured to connect the first signal transmission device and the second signal transmission device;
wherein the first signal transmission device is arranged at a first position and the second signal transmission device is arranged at a second position;
wherein the optical cable is arranged along a wall where the first position is located;
wherein the first optical signal connector is configured to transmit a first optical signal to the second optical signal connector or receive a second optical signal from the second optical signal connector via the optical cable;
wherein the first photoelectric converter is configured to convert a first electrical signal received from an electrical device to the first optical signal or convert the second optical signal to a second electrical signal transmitted to the electrical device.

10. The signal transmission system of claim 9, the first signal transmission device further comprising:
a first fix structure combined with the first circuit board and configured to fix the first circuit board on the wall.

11. The signal transmission system of claim 10, the first signal transmission device further comprising:
a first panel part combined with the first fix structure, and having a first opening corresponding to the first electrical signal connector; wherein the first circuit board is arranged on a first backside of the first panel part.

12. The signal transmission system of claim 9, the first signal transmission device further comprising:
a first signal redriver arranged on the first circuit board and coupled between the first electrical signal connector and the first photoelectric converter, and configured to implement a first redrive process to modify the first electrical signal or the second electrical signal.

13. The signal transmission system of claim 12, wherein the redrive process includes: adjusting a gain setting of at least one channel of the first electrical signal connector.

14. The signal transmission system of claim 9, wherein the first power injector of the first signal transmission device includes an AC input terminal configured to receive an AC power, and a first AC to DC converter configured to convert the AC power to the first working power.

15. The signal transmission system of claim 9, wherein the specification of the first electrical signal connector of the first signal transmission device is selected from one of HDMI, DP and USB.

16. The signal transmission device of claim 9, wherein the specification of the first optical signal connector of the first signal transmission device is selected from one of LC, SC and MPO.

17. The signal transmission device of claim 9, wherein the second signal transmission device has a second signal redriver; wherein the second signal transmission device is configured to provide the first electrical signal to a display device via an electrical signal cable.
